(19) United States
(12) Patent Application Publication
(10) Pub. No.: US 2004/0075070 A1
(43) Pub. Date: Apr. 22, 2004

(54) Control means for gas burners

(76) Inventor: Sybrandus B. Munsterhuis, Hennepin Country, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/048,372

(22) PCT Filed: May 18, 2001
(86) PCT No.: PCT/EP01/05694

(30) Foreign Application Priority Data
May 25, 2000 (DE) 100 26 035.7

(51) Int. Cl. F16K 31/12; F16K 31/02

(52) U.S. Cl. 251/30.02; 251/129.05

(57) ABSTRACT

The invention relates to a control mechanism for gas burners. The control mechanism comprises a main valve and a servo valve, the opening of the main valve being controlled via the servo valve. According to the invention, the actuator for the servo valve is operated in a frequency-modulated, namely pulse-width-modulated way.

### BACKGROUND OF THE INVENTION

The invention relates to a gas burner control mechanism.

Control mechanisms for gas burners are sufficiently known from the prior art. Known control mechanisms for gas burners comprise a main valve, a servo valve and a servo controller wherein, according to the prior art, the servo controller serves to adjust the desired value and to control a gas output pressure. In control mechanisms according to the prior art, a modulation is effected by a modulation coil acting on the servo controller, a variable current being supplied to said modulation coil and changing the adjustments carried out on the servo controller.

### BRIEF SUMMARY OF THE INVENTION

Starting therefrom, the present invention is based on the problem of creating a new kind of control means for gas burners.

This problem is solved by a control means which comprises the features of claim 1.

### BRIEF DESCRIPTION OF THE DRAWINGS

Further advantageous embodiments of the invention result from the description. In the following, a preferred embodiment of the invention is explained in greater detail by means of the drawing. In the drawing,

FIG. 1 shows a schematic diagram of the cross-section of a control means according to the invention in the closed position;

FIG. 2 shows a schematic diagram, also of the cross-section of the control means according to the invention and according to FIG. 1 in the open position;

FIG. 3 shows an example of a pulse width modulation; and

FIG. 4 shows a further example of a pulse width modulation.

### DETAILED DESCRIPTION OF THE INVENTION

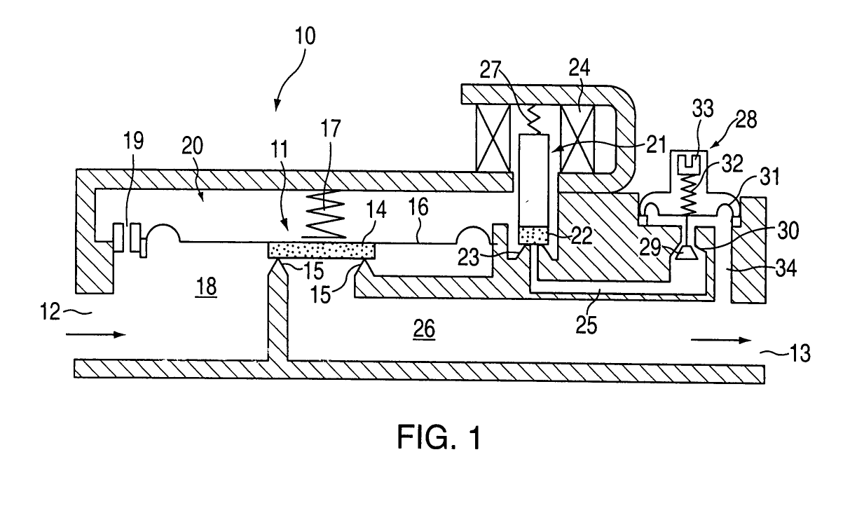

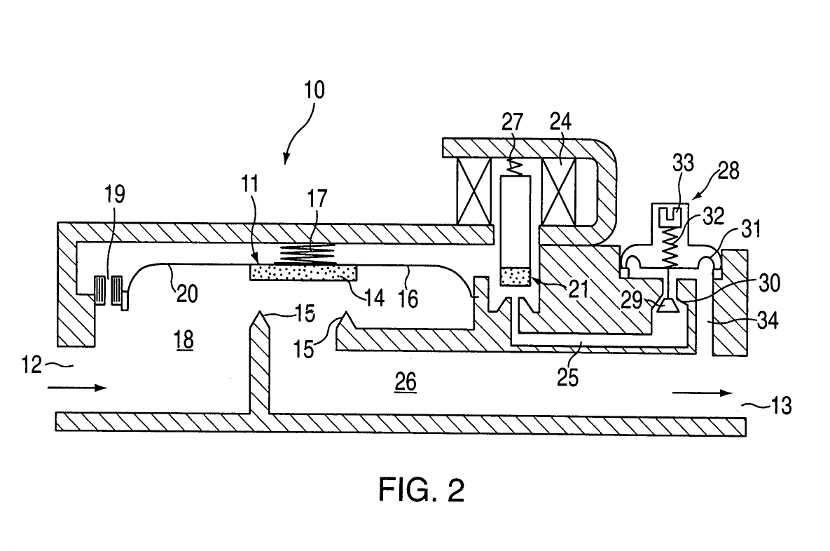

FIG. 1 shows a control means 10 according to the invention in its closed position. Via a main valve 11, a gas flow which flows into the control means in the area of an inlet 12 and leaves the same in the area of an outlet 13 is controlled. According to FIG. 1, the main valve 11 is formed by a valve body 14 resting on a valve seat 15 in the closed position. The valve body 14 is connected to a control diaphragm 16. When the main valve 11 is closed, the valve body 14 is pressed by a spring member 17 against the valve seat 15.

According to FIG. 1, a gas inlet chamber 18, which is disposed below the control diaphragm 16, is communicated via a bore hole 19 with a servo gas chamber 20 positioned above the control diaphragm 16. In this way, when the main valve 11 is closed, the same pressure ranges on both sides of the control diaphragm 16. Furthermore, when the main valve 11 is closed, a servo valve 21 is closed and, in this position, a valve body 22 of the servo valve 21 is pressed against a corresponding valve seat 23, namely by a spring member 27.

Moreover, the control means 10 comprises a servo controller 28, a valve body 29 of the servo controller 28 cooperating with a respective valve seat 30. The valve body 29 of the servo controller is connected to a diaphragm 31 on which also a spring member 32 of a pre-adjusting means 33 of the servo controller 28 acts.

If, now, the main valve 11 of the control means 10 according to the invention is to be opened, the servo valve 21 is opened via an actuator 24 assigned to the servo valve 21 against the force of the spring member 27. In case the servo valve 21 is opened, gas can flow out of the servo gas chamber 20 into a gas outlet chamber 26 via respective bore holes 25 and 34. In this case, the pressure existing in the servo gas chamber 20 drops, and the gas pressure existing in the gas inlet chamber 18 lifts the valve body 14 of the main valve 11 off the valve seat 15.

The servo valve 21 is operated via the actuator 24 dependent on a current heat request. According to the present invention, the actuator 24 is operated in a frequency-modulated, namely pulse-width-modulated way. The servo valve 21 is either completely opened or completely closed by means of a specific frequency, the length of the on-cycles at a specific frequency constituting the actual modulation. Accordingly, the actuator 24 is formed as an on/off actuator 24. The modulation coil, used according to the prior art, which acts on the servo controller may be omitted. Accordingly, in the case of the invention, a modulation is effected by means of the servo valve 21 or the actuator 24, respectively, and not via the servo controller 28.

The opening of the main valve 11 and, thus, the gas flow is determined by the length of the on-cycles of the pulse-width-modulated servo valve 21.

The frequency range which, according to the invention, is typically available for the modulation lies between 10 Hz and 30 Hz. Below a frequency of 10 Hz, undesired disturbances of the output pressure result. At a frequency of above 30 Hz, the mechanical components of the servo valve 21 cannot follow the frequency.

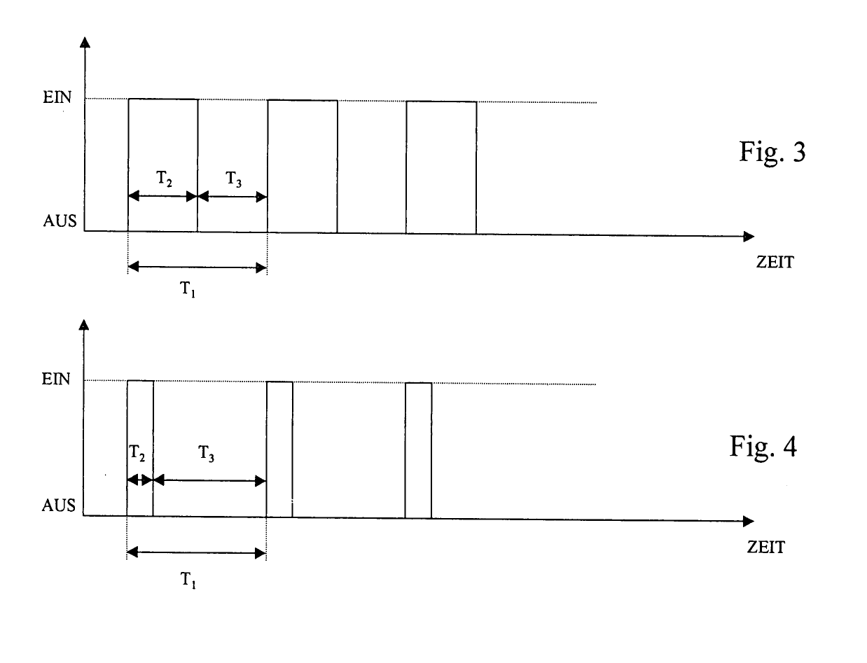

FIG. 3 and FIG. 4 illustrate the modulation principle, e.g. for a frequency of 10 Hz, T₁ then amounting to 0.1 sec. In the modulation shown in FIG. 3, the on-cycle and the off-cycle are equally long, respectively, T₂=T₃=0.05 sec. Thus, the so-called “duty cycle” amounts to 50%. For the modulation at a frequency of 10 Hz, shown in FIG. 4, the duty cycle amounts to 10%, accordingly T₂=0.01 sec, and T₃=0.09 sec. The degree or extent, respectively, of the duty cycle determines the modulation and, in the end, the opening of the main valve. The duty cycle is directly dependent on the heat request.

What is claimed is:

1. A gas burner control mechanism, comprising:
a main valve having an opening, a servo valve, an actuator integral with the servo valve, the opening of the main valve being controlled via the servo valve, wherein the actuator is operated in a frequency-modulated manner such that the servo valve opens and closes in accordance with a frequency input.

2. A gas burner control mechanism according to claim 1, wherein the frequency modulation is a pulse width modulation such that the cycle of the frequency is directly dependent on temperature.

6. The gas burner control mechanism of claim 5 wherein the frequency comprises a square wave the peaks and valleys of which operate to move the valve body into and out of contact with the valve seat.

7. The gas burner control mechanism of claim 6 wherein the peaks have a first width and the valleys have a second width so that the amount of time that the valve is open compared to the amount of time that the valve is closed depends on the first and second widths.

8. The gas burner control mechanism of claim 7 in which modulation of the gas burner is controlled by controlling the first and second widths.

9. The gas burner control mechanism of claim 5 wherein the valve body is biased into contact with the valve seat by a spring.

10. A gas flow control mechanism for providing a modulated flow of between an inlet and an outlet comprising:
a main valve operable to open and close a main gas flow path between the input and the output;
a flexible member separating the input from a chamber, the flexible member connected to the main valve and, in a first position, causing the main valve to close the main gas flow path and in a second position to open the main gas flow path;
a bore hole connecting the input to the chamber so that the gas pressure becomes equalized on both sides of the flexible member when it is in the first position;
a secondary valve operable to open and close a secondary path from the chamber; and,
an actuator operable to open the close the secondary valve under the influence of a frequency modulation signal and, when open, the gas in the first chamber flows through the secondary path to reduce the gas pressure in the chamber so that the flexible member moves to the second position.

11. The gas flow control mechanism of claim 10 wherein the flexible member is biased by a spring so that the flexible member is in the first position when the gas pressure is equalized on both sides of the flexible member and is in the second position when the gas pressure in the chamber is reduced.

12. The gas flow control mechanism of claim 11 wherein the main valve includes a valve body and a valve seat, one of which is connected to the flexible member so that, when in contact, the main valve flow path is closed and when open, the main valve flow path is open.

13. The gas flow control mechanism of claim 11 wherein the frequency modulation comprises a square wave the peaks and valleys of which operate to open and close the secondary valve so as to move the valve body and valve seat into and out of contact.

14. The gas flow control mechanism of claim 13 wherein the peaks have a first width and the valleys have a second width so that the amount of time that the main valve flow path is open compared to the amount of time that the main valve flow is closed depends on the first and second widths.

15. The gas flow control mechanism of claim 14 in which modulation of the flow is controlled by controlling the first and second widths.

16. A valve mechanism comprising:
a main valve operable to open and close a path for fluid between an inlet and an outlet;
a servo valve operable to control the operation of the main valve; and
an actuator driven by a frequency-modulated signal to operate the servo valve so that the main valve opens and closes the path in a modulated manner.

17. The valve mechanism of claim 16 wherein the main valve is connected to a diaphragm which biases the main valve to close the path when the pressure of the fluid is substantially equal on both sides of the diaphragm and to open the path when the pressure of the fluid on a first portion of the diaphragm is less that the pressure of the fluid on a second portion of the diaphragm.

18. The valve mechanism of claim 17 wherein the servo valve operates to reduce the pressure on the first portion of the diaphragm.

19. The valve mechanism of claim 18 wherein the servo valve opens and closes a secondary path which controls the flow of fluid from the first portion of the diaphragm to thereby reduce the pressure thereon.

20. The valve mechanism of claim 19 wherein the frequency-modulated signal is a square wave the peaks of which open the servo valve and the valleys of which close the servo valve, the open and closed times of the servo valve being controlled by the width of the peaks and valleys.
